(19) United States
(12) Patent Application Publication
(10) Pub. No.: US 2024/0368019 A1
(43) Pub. Date: Nov. 7, 2024

(54) GLASS STRUCTURES AND ASSEMBLY OF THE SAME VIA LASER WELDING

(71) Applicant: CORNING INCORPORATED, CORNING, NY (US)

(72) Inventors: Stuart Gray, Corning, NY (US); Ying Liu, Kennett Square, PA (US); Alranzo Boh Ruffin, Painted Post, NY (US); Craig John Mancusi Ungaro, Corning, NY (US)

(21) Appl. No.: 18/646,996

(22) Filed: Apr. 26, 2024

Related U.S. Application Data
(60) Provisional application No. 63/463,201, filed on May 1, 2023.

(51) Int. Cl. C03B 23/203; B23K 26/21; B23K 26/324; B23K 103/00; G02B 5/08

(52) U.S. Cl. CPC C03B 23/203; B23K 26/21; B23K 26/324; B23K 2103/54; G02B 5/08

(57) ABSTRACT

Disclosed are various embodiments of glass structures and the assembly of the same by way of laser welding. In one embodiment, the glass structures may comprise a lightweight mirror or other structure. In constructing a lightweight mirror, a core is assembled by creating laser welded joints between individual ones of a plurality of glass parts. At least one laser access opening is cut out in one or more of the glass parts or plates. In the assembling, various pairs of glass parts are positioned to create abutments therebetween. Further, a laser is directed through at least one laser access opening toward at least one of the abutments to create one or more of the laser welded joints.

This application claims the benefit of priority under 35 U.S.C § 120 of U.S. Provisional Application Ser. No. 63/463,201 filed on May 1, 2023, the content of which is relied upon and incorporated herein by reference in its entirety.

### BACKGROUND

Present methods of making large assemblies require fixturing pieces of glass together and heating the large part assembly in a large furnace environment to the point where the viscosity of the glass is sufficiently low that the glass pieces fuse together at their points of contact. While this method can make large assemblies, it is essentially an “all-or-nothing” process.” If something goes wrong, for example, a part of the fixture moves or the temperature environment in the furnace is uneven; the entire assembly may be useless and have to be discarded. This is both costly and time consuming.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a portion of a lightweight mirror that shows an example of a core sandwiched between a first and second plate according to an embodiment of the present disclosure.

FIG. 2A is a drawing of one example of a core structure positioned on a first plate of FIG. 1 according to various embodiments of the present disclosure.

FIG. 2B is a drawing of another example of a core structure positioned on a first plate of FIG. 1 according to various embodiments of the present disclosure.

FIG. 3 is a drawing of an elongated glass part that is part of the core of FIG. 1 with regions conditioned for laser cutting according to various embodiments of the present disclosure.

FIG. 4 is a drawing of the elongated glass part of FIG. 3 with laser access openings created by laser cutting according to various embodiments of the present disclosure.

FIGS. 5A and 5B depict angles relative to a surface of the elongated glass part at which the laser cutting of FIG. 4 may be performed according to various embodiments of the present disclosure.

FIG. 6 is a drawing depicting assembly of the core of FIG. 1 by laser welding of rib glass parts to the elongated glass part of FIG. 4 according to various embodiments of the present disclosure.

FIG. 7 is a drawing that depicts a laser welding operation between two glass parts such as a rib glass part and the elongated glass part of FIG. 4 according to an embodiment of the present disclosure.

FIG. 8 is a drawing depicting further assembly of the core of FIG. 1 by laser welding of rib glass parts to a second elongated glass part according to various embodiments of the present disclosure.

FIG. 9 is a drawing depicting laser welding of the core of FIG. 1 to a first plate according to various embodiments of the present disclosure.

FIG. 10 is a drawing depicting a polishing of the exposed ends of the glass parts making up the core of FIG. 1 before laser welding to a second plate by way of transmission welding according to various embodiments of the present disclosure.

FIG. 11 is a drawing depicting direct laser welding of the core of FIG. 1 to a second plate according to various embodiments of the present disclosure.

FIG. 12 is a drawing depicting transmission laser welding of the core of FIG. 1 to a second plate according to various embodiments of the present disclosure.

FIG. 13 depicts a flow chart that illustrates one example of a method for assembling a core of FIG. 1 and laser welding the core to first and second plates according to an embodiment of the present disclosure.

FIG. 14 is a drawing depicting the constructure of a core comprising a plurality of hexagons according to various embodiments of the present disclosure.

### DETAILED DESCRIPTION

In the following discussion, the construction of lightweight mirrors, mirror segments, and other structures is described. In one embodiment, such lightweight mirrors may be employed in applications such as ultra-low expansion lightweight telescopes used in satellites and other applications. In one embodiment, mirror blanks are manufactured from three separate components that are then assembled as a “sandwich.” A plate of the mirror blank is polished to receive a mirror as will be described. Alternatively, the various embodiments described herein also apply to other applications such as micro-optics, photonics, microelectromechanical systems (MEMS), nanoelectromechanical systems (NEMS), and other applications.

In the following discussion, a general description of the system and its components is provided, followed by a discussion of the operation of the same.

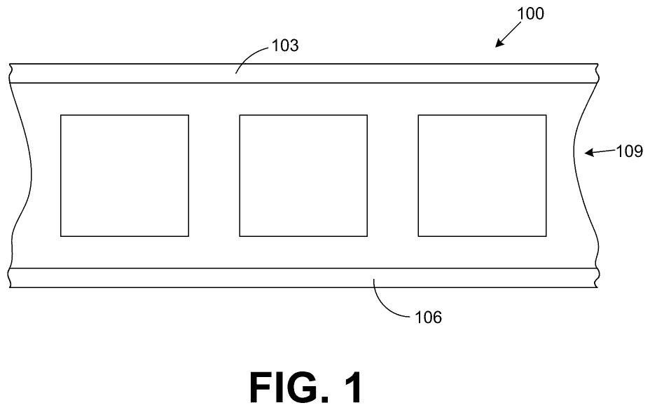

With reference to FIG. 1, shown is an example of a portion of a mirror blank 100 according to various embodiments. The mirror blank 100 includes a first plate 103 and a second plate 106. The first and second plates 103 and 106 are formed, for example, from a boule that may vary in size depending on the specific application. For example, a boule may have a diameter of 1 meter or another diameter. A typical boule may have a thickness of around 2-3 inches, although the thickness of a boule vary beyond 2-3 inches as can be appreciated.

The first and second plates 103 and 106 are separated by a core 109, that is sandwiched between the first and second plates 103 and 106. In one embodiment, the core 109 is constructed from a number of glass parts that are assembled together by way of laser welding as will be described. Also, the core 109 may be constructed of a number of core substructures that are laser welded together as will be described.

In one embodiment, the core 109 is constructed from glass parts that are in the form of glass sheets, panels, or other structures as will be described. The first plate 103 is attached to the various glass parts that make up the core 109 by way of one or more laser welded joints (not shown) as will be described. Also, the second plate 106 is, likewise, attached to the various parts that make up the core 109 by way of one or more laser welded joints (not shown) as will be described. In one embodiment, an exposed surface of one of the first or second plates 103 or 106 serves as a mirror surface to be used, for example, as part of a telescope, where the mirror surface may be ground and polished to the required shape and finish. In one embodiment, one of the first or second plates 103 or 106 may have a first side that forms a plane, and a second side that is concave to accommodate a mirror surface.

The first plate 103, the second plate 106, and the core 109 may be constructed from various different glass materials depending on the application for which the first plate 103, the second plate 106, and the core 109 are used. In one embodiment, any appropriate glass material may be used that is compatible with the various construction techniques discussed herein. In one specific embodiment, the glass material that is employed in creating the various components described herein may comprise any one of a number of different Low Thermal Expansion (LTE) glasses.

As contemplated herein, Low Thermal Expansion (LTE) glass refers to all types of glass and glass-ceramics that have an instantaneous Coefficient of Thermal Expansion (CTE) of 0±45 ppb/° Celsius (or 0±45×10⁻⁹/Kelvin) or less over the approximate temperature range of 5° Celsius to 35° Celsius. An example of Low Thermal Expansion glass as contemplated herein is ULE® glass manufactured by Corning Incorporated of Corning, New York.

Types of glass other than Low Thermal Expansion glass may also be used. An example of glass that is not of the Low Thermal Expansion variety that may be used includes fused silica such as HPFS® that is manufactured by Corning Incorporated of Corning, New York (a registered mark for high purity fused silica). Further types of glass material that is not of the Low Thermal Expansion variety that may be employed include, for example, Eagle XG® (manufactured by Corning Incorporated of Corning, New York), Gorilla® Glass (manufactured by Corning Incorporated of Corning, New York), and other types of glass material.

Alternatively, as contemplated herein, in one embodiment, Low Thermal Expansion glass comprises silica-titania glass that has a titania (TiO₂) content in the range from 7.1 wt % to 7.5 wt %, or in the range from 7.0 wt % to 7.5 wt %, or in the range from 6.5 wt % to 8.0 wt %, or in the range from 7.0 wt % to 8.5 wt %, or in the range from 7.0 wt % to 9.0 wt %, or in the range from 7.0 wt % to 10 wt %, or in the range from 7.5 wt % to 8.0 wt % or in the range from 7.5 wt % to 9.0 wt %, or in the range from 8 wt % to 9 wt %, or in the range from 6 wt % to 10 wt %, or in the range from 6 wt % to 11 wt %, or in the range from 5 wt % to 12 wt %.

In order to accomplish laser welding of glasses that are not Low Thermal Expansion glasses, it may be necessary to heat the glasses before welding to minimize thermal stress involved during laser welding. Also, fast welding techniques may be employed using an Yttrium Aluminum Garnet (YAG) laser with a wavelength of around 1060 nm. Alternatively, other lasers with wavelengths in the range, for example, of 512 nm to 532 nm may be employed. Such lasers may be pulsed lasers with pulses measured, for example, in terms of picoseconds or other pulse width.

The structure comprising the first and second plates 103 and 106 with a core 109 sandwiched therebetween provides for a lightweight mirror according to various embodiments. Given that the core 109 is attached to the first and second plates 103 and 106 by way of laser welded joints, a desired degree of rigidity is imparted to the overall structure. As such, the lightweight mirror can be constructed with required rigidity for various purposes with a high degree or precision and control over morphology.

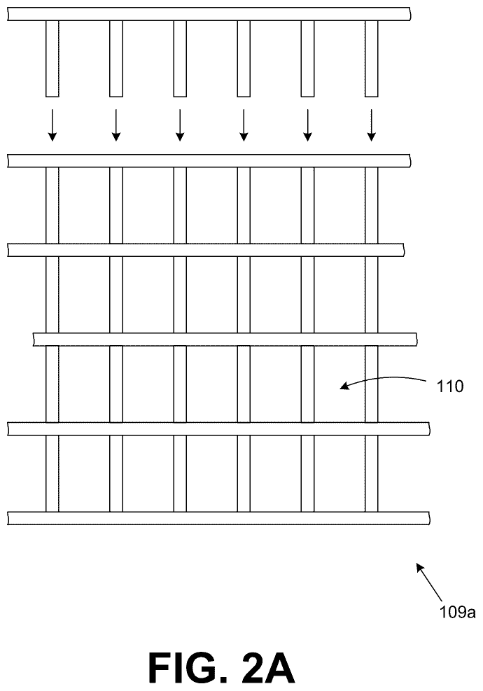

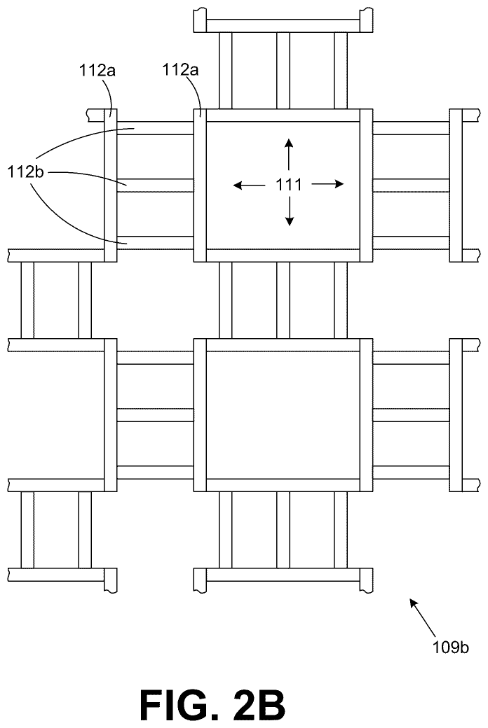

With reference to FIG. 2A, shown is a view of a core 109 (FIG. 1), denoted herein as core 109a, that is assembled and ultimately attached to the first plate 103 and the second plate 106 according to one embodiment. Alternatively, the core 109a may be attached only to the first place 103 where an “open back” design for a mirror or other structure is desired.

As shown, the core 109 comprises a predefined pattern as glass parts are attached to each other by way of laser welding before the core 109 is attached to the first plate 103 (FIG. 1). Thereafter, the core 109 is attached to the second plate 106 (FIG. 1) as will be described. The pattern may vary such that the individual cells 110 are formed. The cells 110 may vary in size depending upon the structural integrity and rigidity that is required of the resulting lightweight mirror. In one embodiment, the shape of the cells 110 is rectangular, although the cells 110 may be embodied in shapes other than a rectangle.

Referring next to FIG. 2B, shown is an example of a core 109 (FIG. 1) denoted herein as core 109b according to one embodiment. The core 109b comprises a plurality of core sub-components 111 that are connected together, for example, by way of laser welding or other means of attachment. Each of the core subcomponents 111 comprises two side pieces 112a and a plurality of ribs 112b. Although the core subcomponents 111 depicted in FIG. 2B are rectangular in shape, it is understood that the core subcomponents 111 may be constructed in many different shapes, where such core subcomponents 111 are attached to each other to form an entire core 109b. Such a core 109b may then be attached to first and second plates 103 (FIG. 1) and 106 (FIG. 1) as described above.

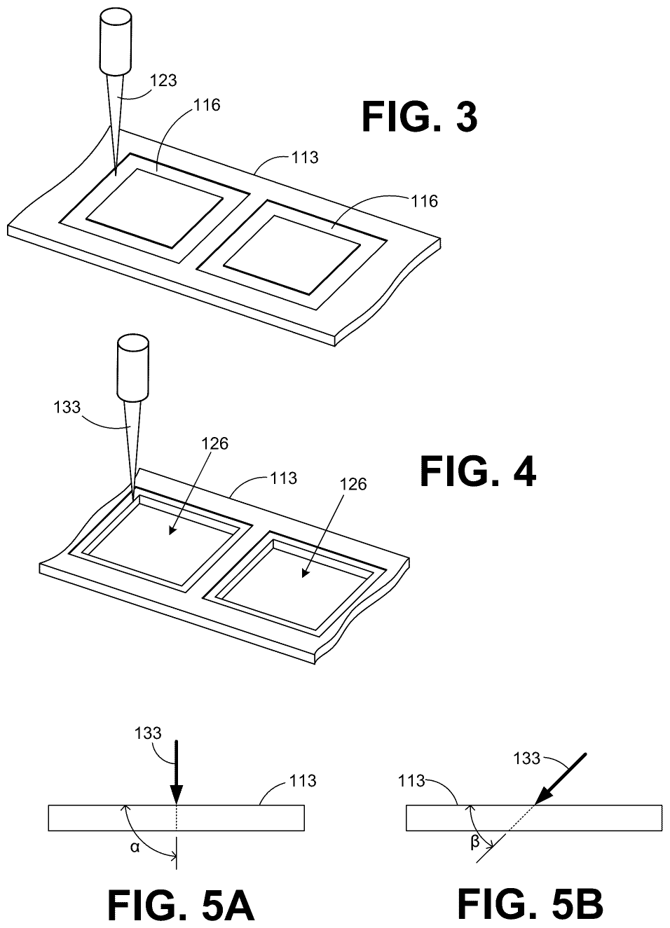

Next a description of how one embodiment of a core 109 is assembled with reference to FIGS. 3, 4, 5, and 6. Referring to FIG. 3, assembly of the core 109 begins with an elongated glass part 113 according to an embodiment of the present disclosure. In one embodiment, the length of an elongated glass part 113 may be specified to span between the edges of a portion of a mirror or other structure. In this respect, the length of a given elongated glass part 113 may span a distance as long as a diameter of a round mirror. In one example, such mirrors may have a diameter of 1 meter or more when used in telescopes or other devices. The width of the elongated glass part 113 may be measured in terms of several centimeters, where the width may vary depending upon a desired rigidity of the resulting core structure.

In one embodiment, laser access openings are to be cut in the elongated glass part 113. Before the laser access openings in the elongated glass part 113 are cut, a conditioning of regions 116 specified on a surface of the elongated glass part 113 is performed, where the cutting through the elongated glass part 113 is performed within the regions 116. Although two regions 116 are shown, it is understood that there may be any number of regions 116 along the length of the elongated glass part 113 depending on how many laser access openings are to be created along the length of the elongated glass part 113.

In one embodiment, the conditioning of the regions 116 involves smoothing by polishing via scanning with a carbon dioxide (CO₂) laser 123. In one embodiment, a CO₂ laser 123 is focused on to the surface of the elongated glass part 113 to be polished with enough power that the surface of the glass melts and lows under surface tension to form a smooth surface. In one embodiment, the elongated glass part 113 to be polished is moved through the focal point of the CO₂ laser 123 to expose the CO₂ laser 123 to the regions 116. Alternatively, the CO₂ laser 123 is scanned along the regions 116 to generate the required laser polishing in the regions 116.

In one embodiment, laser polishing is accomplished, for example, with a laser power of 60 Watts focused to spot diameter of 3 mm although other power/diameters may be used. Also, relative motion between the CO₂ laser 123 and the region 116 being polished may be, for example, approximately 2 mm/see or other appropriate speed to accomplish acceptable results. The laser polishing process is performed in the regions 116 with an aim of enabling a laser cutting process to cut out laser access openings as will be described. For example, the smoothing process is performed to achieve an Arithmetic Roughness Average Ra in the regions 116 of approximately 1 micron, although other smoothness benchmarks may be adequate to facilitate effective cutting through the elongated glass part 113.

In alternative embodiments, the conditioning of the regions 116 may be accomplished using an index matching fluid, gel, or polymer. In such case, the index matching fluid, gel, or polymer may be used to wet or spin coat the top surface of the regions 116 or the entire surface of the elongated glass part 113 prior to laser cutting. This approach can provide a smooth surface for a cutting laser to pass through the elongated glass part 113.

Referring to FIG. 4, next laser access openings 126 are cut in the elongated glass part 113 according to one embodiment. In one embodiment, a cutting method that may be used is nanoperforation (nP). Using this process, a pulsed near infrared (NIR) laser 133, denoted herein as “NIR laser 133,” comprising a pseudo-nondiffracting beam such as a Gaussian-Bessel beam (often referred to simply as a Bessel beam) is formed using a pulsed ultrafast laser of a wavelength to which the elongated glass part 113 is transparent. For example, an NIR laser 133 may be employed with a focal area that is less than 5 μm in diameter and 1-5 mm long. Under these conditions, the low-intensity laser light outside the beam's focal region can pass through the substrate without significant absorption. However, the high-intensity light in the focal region will be absorbed due to nonlinear absorption processes. In one embodiment, the glass material is transparent at the wavelength of the laser. As contemplated herein, a material is “transparent” if it absorbs less than 10 percent of the energy of the laser per millimeter of distance traveled through the material by the laser at the wavelength of the laser.

As a result, each laser shot creates a long, thin line through the entire thickness of the elongated glass part 113. The NIR laser 133 may be moved relative to the elongated glass part 113, or the elongated glass part 113 moved relative to the NIR laser 133, such that each shot connects with previous shots and a weakened crack or line is formed in the elongated glass part 113. Mechanical force may then be applied to remove the glass piece by hand, by a four point bend, by thermal means such as with a CO₂ laser, or by some other means, thereby creating a laser access opening 126. Alternatively, chemical etching may be employed to release the glass piece by penetrating the cracks in the laser damaged area and etch out the remaining glass.

In one example, an NIR laser 133 cutting through the elongated glass part 113 by nanoperforation comprises a 1030 nm laser with an 8 picosecond pulse width, and a 10 kHz repetition rate, where a 200 μJ pulse of energy is guided through an optical system consisting of a 10° glass axicon followed by two lenses with focal lengths of 75 mm and 15 mm respectively, in a 4f configuration. A Bessel beam was formed at the focus of the final lens. It should be noted that other types of lasers may be employed beyond NIR lasers for purposes of cutting through the various glass parts as described herein where NIR lasers are cited as an example.

In one embodiment, the speed or rate of the relative motion of the elongated glass part 113 and the laser 133 is specified such that there was a 1 μm pitch between laser shots. Care was taken to ensure that the NIR laser 133 is positioned substantially near the center of the laser polished region 116 so that the full NIR laser 133 is able to pass through the elongated glass part 113. To this end, the width of the conditioned region 116 (FIG. 3) is specified to accommodate the full width of the laser 133 that is used.

With reference to FIG. 5A, shown is an example of an NIR laser 133 as it cuts through a glass part such as the elongated glass part 113. As shown, in one embodiment, the NIR laser 133 is directed such that a cut is made at an angle α that is substantially 90 degrees relative to a surface of the elongated glass part 113. As such, the interior edge of the resulting laser access opening 126 (FIG. 4) is substantially perpendicular to a surface of the elongated glass part 113.

Referring then to FIG. 5B, shown is another example of an NIR laser 133 as it cuts through a glass part such as the elongated glass part 113. In this embodiment, the NIR laser 133 is directed such that a cut is made at an angle β that is less than 90 degrees relative to a surface of the elongated glass part 113. As such, an angle between the interior edge of the resulting laser access opening 126 (FIG. 4) and a surface of the LTE glass part is less than 90 degrees.

With reference to FIGS. 5A and 5B, as shown the angle at which a cut is made to create the laser access opening can vary as needed to allow a direct line-of-sight by a laser to an abutment between glass parts to form a laser welded joint as will be described. Also, an angled cut may provide a direct line-of-sight by a laser to a given abutment while at the same time, preserving more material of the elongated glass part 113 for greater rigidity of the resulting lightweight mirror where desired.

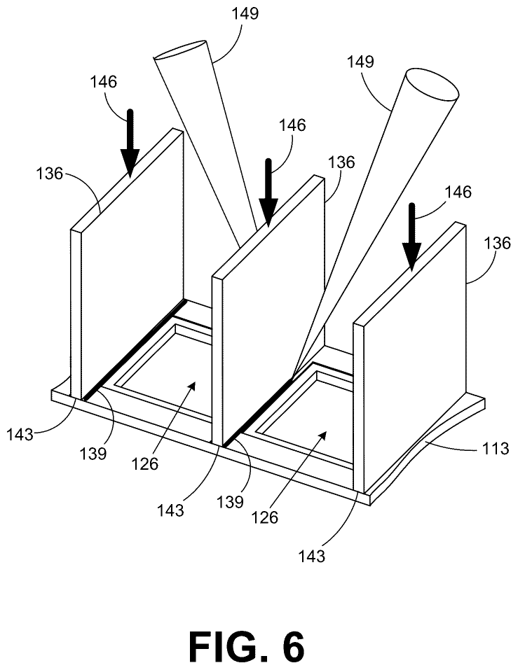

Referring next to FIG. 6, shown is a view of the further assembly of a portion of the core 109 (FIG. 1) according to various embodiments. At this stage of the assembly of the core 109, rib glass parts 136 are attached to the elongated glass part 113 by way of laser welded joints 139. In one embodiment, each rib glass part 136 is attached to a surface of the elongated glass part 113 at a location that bridges between a respective pair of laser access openings 126 as shown.

In order to create the laser welded joints 139, an end of each of the rib glass parts 136 are held against the elongated glass part 113 to create an abutment 143 between the end of each rib glass part 136 and the elongated glass part 113. Thus, in each abutment, the end of a respective rib glass part 136 comes into contact with the surface of the elongated glass part 113.

A degree of force 146 is applied in holding each of the rib glass parts 136 against the elongated glass part 113. In this way, the rib glass parts 136 are held against a surface of the elongated glass part 113 in a pressured contact. As contemplated herein, a “pressured contact” refers to the condition when a surface of one part is brought into contact with a surface of another part and a force 146 is exerted on the respective parts to keep them in contact with one another and/or to hold any object that may be inserted between the parts. In order to hold the rib glass parts 136 against the elongated glass parts 113 creating respective abutments, the rib glass parts 136 and the elongated glass parts 113 may be held in place using an appropriate fixture that also provides a clear line of sight to the sides of the abutments 143 such that a welding laser 149 may be directed to the abutments 143 to create a laser welded joint 139.

In one embodiment, each laser welded joint 139 is continuous in that the laser welding of the joint is consistent along the entire length of the joint. Alternatively, the laser welded joints 139 may be spot or segment welded at predefined locations as is appropriate to achieve the desired rigidity and structural integrity of the resulting lightweight mirror.

In one embodiment, the welding laser 149 may comprise, for example, a carbon dioxide (CO₂) laser or other appropriate laser may be employed to cause the melting of glass to weld the laser welded joints 139. In a further embodiment, a welding laser 149 applied to each side of a given abutment to heat the region of contact between respective glass parts until the glass melts and the respective glass parts such as the rib glass parts 136 and the elongated glass part 113 fuse together.

To make a continuous laser welded joint 139, the rib glass parts 136 and the elongated glass part 113 can be fastened into place in a fixture and moved such that the side of the abutment 143 is moved through the focus region of a welding laser 149. Alternatively, the welding laser 149 may be directed to, and scanned along, the side of the abutment 143 as needed to create a given laser welded joint 139.

In welding a given abutment 143 between respective glass parts to form a laser welded joint 139, the angle between the welding laser 149 and the base piece of glass such as the elongated glass part 113 is usually in the range of 45-60 degrees. This angle can also fall outside of this range depending on the specific geometry of the respective glass parts. In one embodiment, the diameter of the welding laser 149 at the weld location is in the range of 5-10 mm.

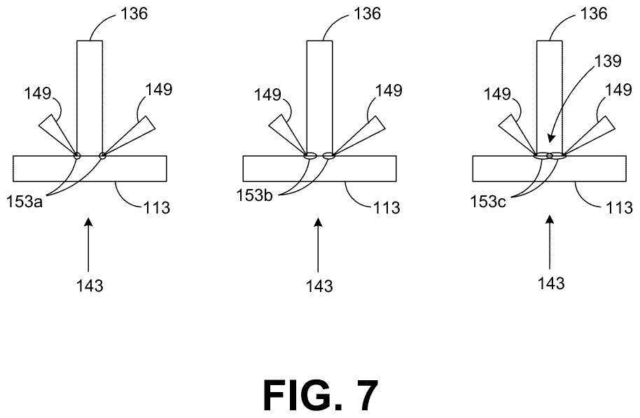

Referring next to FIG. 7, discussed is one embodiment where consistent and high quality laser welded joints 139 are more readily achieved when using multiple passes of the welding laser 149 at various different speeds and powers along the edge of a given abutment. As depicted in FIG. 7, shown are three different laser welding passes on a given abutment 143, for example, between a rib glass part 136 and an elongated glass part 113. A first pass is made at a relatively high speed that creates a welded area 153a that bonds the very outer edge of the abutment 143. Each successive pass is made at a slower speed allowing the thermal energy absorbed at the surface of the glass to penetrate more deeply into the joint and increase the thickness of the welded area 153a-c. Thus, the second pass is made at a slower speed than the first pass resulting in welded area 153b. The third pass is made at a slower speed than the second pass resulting in deeper penetration of the weld such that the welded area 153c involves the full depth of the abutment 143.

As the speed of a given scan of a welding laser 149 along the abutment 143 decreases, the corresponding laser power is also decreased to prevent overheating of the glass surface and minimize volatilization of the glass. In one example, the welding parameters used for welding a 1.8 mm thick rib glass part 136 (FIG. 6) to an elongated glass part 113 that is 6 mm thick where these parts are made of LTE glass such as ULE® glass manufactured by Corning Incorporated of Corning, New York include a first pass at a speed of 1 mm/s with a laser power set at 280 Watts, a second pass at 0.5 mm/s with a laser power set at 270 Watts, and a third pass at 0.2 mm/s with a laser power set at 250 Watts. However, it is understood that other speeds and laser powers may be specified depending on the type of glass used and potentially other parameters.

It should be noted that in order to fuse LTE glass parts to one another the laser system used to weld such LTE glass must be of sufficient power and have a wavelength that can be absorbed by the respective type of LTE glass. That is, the laser must be capable of heating the glass to at least the softening point of the glass so that the glass will flow together to form a joint or weld.

For a LTE glass such as ULE® glass, a carbon dioxide laser welding system is suitable and commercially available. Silica LTE glasses have good properties for laser melting and machining, which result from the strong absorption of carbon dioxide laser light that gives a small melt depth. A carbon dioxide laser can provide power in the range of 50 to 15,000 watts, which assures that sufficient power is available to weld high softening point glasses such as ULE® glass that has a softening point of approximately 1490° Celsius or HPFS that has a softening point of 1585° Celsius.

There are several important issues to be considered when joining glass components to form larger assemblies. For one, the energy density at the area where the glass pieces are being joined must be carefully controlled in order to avoid localized vaporization of glass material that can result in defects, for example, in optical elements or other defects.

In addition, residual stress formation should be minimized. Stress in the glass can induce birefringence, which can affect the performance of the final product, for example, by causing distortion of any transmitted or reflected light.

Also, an abutment 143 where glass pieces are joined together should have high mechanical strength. The surface geometry of the joint should also be maintained. For example, a laser welded joint 139 should match the geometry of the adjacent glass area and should not have any defects such as, for example slumping, that cannot be easily removed such as by grinding, lapping, and polishing.

When welding glass pieces or parts, as opposed to glass-ceramics, there should be no glass crystallization around the joint when glass pieces are joined together. Crystallization can occur during sealing or fusing. Surface crystallization in the area of a laser welded joint 139 tends to be promoted on ground, polished, sawed or otherwise uncleaned surfaces and can prevent good bonding of the parts. Hence, the surfaces should be properly cleaned by acid washing, for example, before being joined.

In addition, as contemplated herein, a laser welded joint 139 comprises an attachment between glass parts. Such an attachment may involve welding on one side or both sides of a glass part abutted against a second glass part. A laser welded joint 139 may or may not be continuous along the entire length of a given abutment. For example, a laser welded joint 139 between two glass parts may involve spot or segment welding at predefined locations along a given abutment. In addition, a laser welded joint 139 may or may not penetrate deeply into a given abutment such that the welded area 153a-c may or may not involve the full depth of a given the abutment. For example, a given laser welded joint 139 may involve a welded area 153a/b on one side of an abutment, or on both sides of the abutment. If such welded areas 153a/b are on both sides of a laser welded joint 139, they may or may not meet in the middle of the abutment.

Referring back to FIG. 6, as mentioned above the rib glass parts 136 are positioned against the elongated glass part 113, thereby creating abutments 143. The rib glass parts 136 are held against the elongated glass part 113 with appropriate contact pressure by placing these items in fixture.

The welding laser 149 is directed to both sides of a given abutment 143 to create a complete laser welded joint 139. Multiple passes of the welding laser 149 may be made along the sides of the abutment 143 to form a laser welded joint 139. In one embodiment, the laser access openings 126 are cut on the elongated glass part 113 as mentioned above and a rib glass part 136 is positioned between the laser access openings 126 and laser welded to the elongated glass part 113.

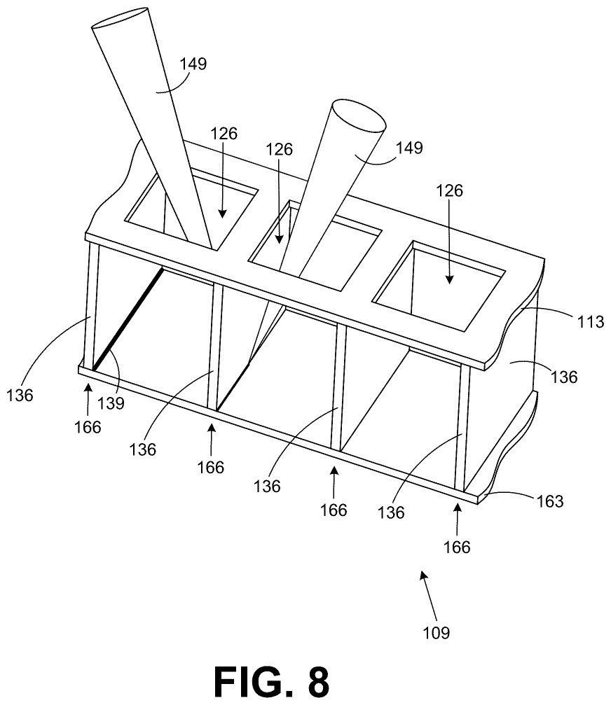

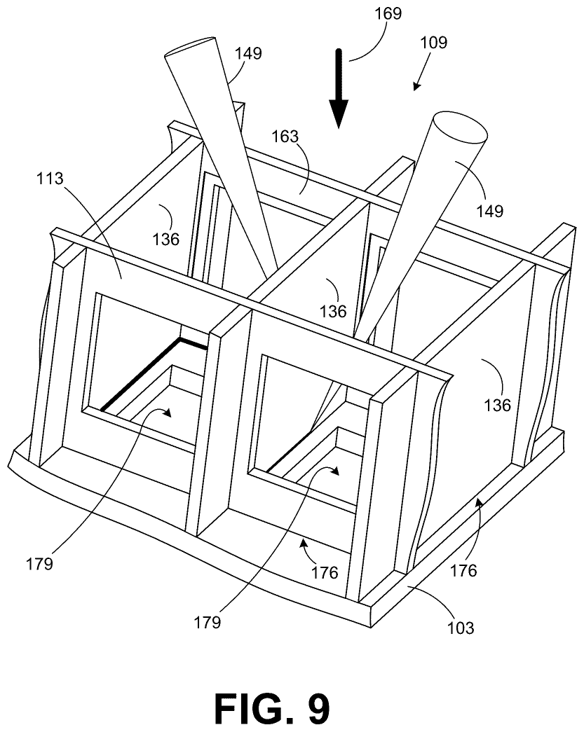

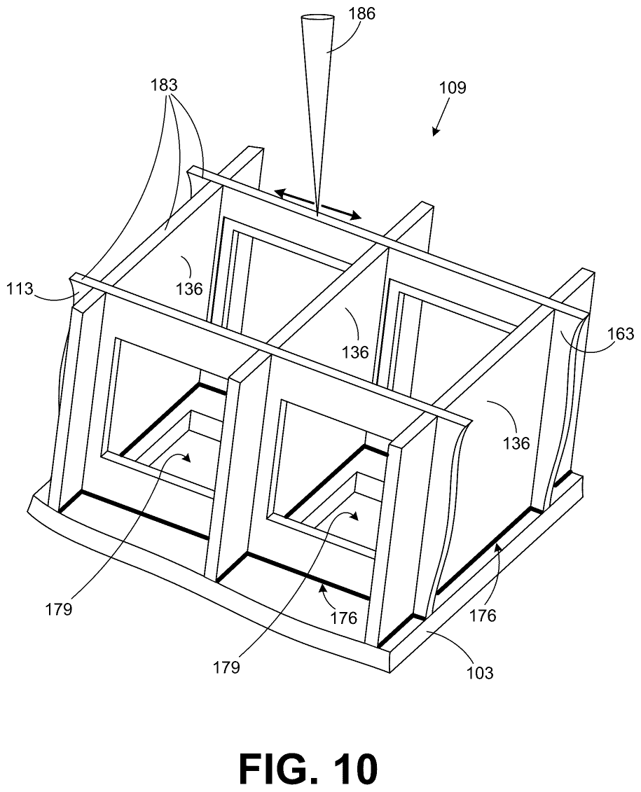

Referring next to FIG. 8, shown is an additional step in the assembly of the core 109 according to one embodiment. Once the rib glass parts 136 are laser welded to the elongated glass part 113, then the resulting assembly is flipped over and the free ends of the rib glass parts 136 are placed in contact with a second elongated glass part 163, thereby creating further abutments denoted herein as abutments 166. In this manner, the assembly comprising the elongated glass part 113 and the rib glass parts 136 that are laser welded thereto, and the second elongated glass part 113 may be placed in a fixture that holds these components so as to create the abutments 166.

Thereafter, a welding laser 149 is directed to the sides of the abutments 166 to form laser welded joints 139. For the sides of the abutments 166 that face toward the outside of the core 109, the welding laser 149 is directed to the outer side of the abutments 166 to laser weld the respective rib glass parts 136 to the second elongated glass part 163. For the sides of the abutments 166 that are located in the interior of the core 109, the welding lasers 149 are directed through a respective one of the laser access openings 126 toward a side of a respective abutment 166 to create at least portion of one of the laser welded joints 139.

For each of the abutments 166, the welding laser 149 is moved, or the core 109 is moved, so that the welding laser 149 scans across an edge of a respective one of the abutments 166. In this manner, the welding laser 149 can make multiple passes across the edge of each of the abutments 166 to create a portion of a laser welded joint 139 from a given side as described above.

It is also noted that when the assembly of the core 109 as depicted in FIG. 8 is complete, the core 109 forms a grid of internal rectangular cells 110 (FIG. 2A). However, it is understood that a core 109 may be constructed such that the individual cells are formed in one of many different shapes such as any polygon, circle, ellipse, or other shape as will be described below.

Referring next to FIG. 9, shown is a view that illustrates attachment of a portion of the core 109 to a first plate 103 according to one embodiment.

Specifically, FIG. 9 depicts the laser welding of the portion of the core 109 to a first plate 103. The core 109 is positioned on the first plate 103 thereby creating a plurality of abutments between the respective glass parts of the core 109 and the first plate 103 (denoted herein as abutments 176), where such contact is a pressured contact by virtue of a force 169 that is applied by a fixture that holds the core 109 against the first plate 103. In one embodiment, the glass parts of the core 109 that come into contact with the first plate 103 include the elongated glass parts 113 and 163 as well as the rib glass parts 136. According to one embodiment, the first plate 103 is used as the back of a lightweight mirror structure to provide greater structural integrity and rigidity to the lightweight mirror.

Once the core 109 is positioned against the first plate 103, a welding laser 149 is directed toward the sides of the abutments 176 to create a plurality of laser welded joints 139, thereby attaching the core 109 to the first plate 103. The welding of the abutments 176 is accomplished, for example, with multiple passes in a manner as was described above with respect to FIGS. 6 and 7.

In addition, according to one embodiment, laser access openings denoted herein as laser access openings 179 are cut in the first plate 103. The cutting of the laser access openings 179 is accomplished in a manner as was described above with reference to FIGS. 3, 4, 5A, and 5B. In this respect, regions on the first plate 103 are conditioned (not shown) as was described above with respect to FIG. 3 and the laser access openings 179 are cut out in a manner as described with reference to FIGS. 4, 5A, and 5B.

Assuming that laser access openings 179 are created in the first plate 103, then the core 109 is positioned such that the laser access openings 179 are located within the cells 110 (FIG. 2A) of the core 109 to facilitate the laser welding of joints with a second plate 106 (FIG. 1) as will be described.

It is noted that the creation of laser access openings 179 results in a lighter mirror structure given the removal of material as was described with reference to FIG. 4 above. Thus, there is a trade-off to be made in constructing a lightweight mirror as described herein. On one hand, the structure is made lighter by the removal of material to create the laser access openings. On the other hand, a mirror that is ultimately constructed needs to meet minimum predefined structural integrity and rigidity requirements. Thus, the size of the laser access openings may be specified to provide the needed laser access to create laser welded joints 139 and achieve desired lighter weight targets, but at the same time provides for required structural integrity and rigidity.

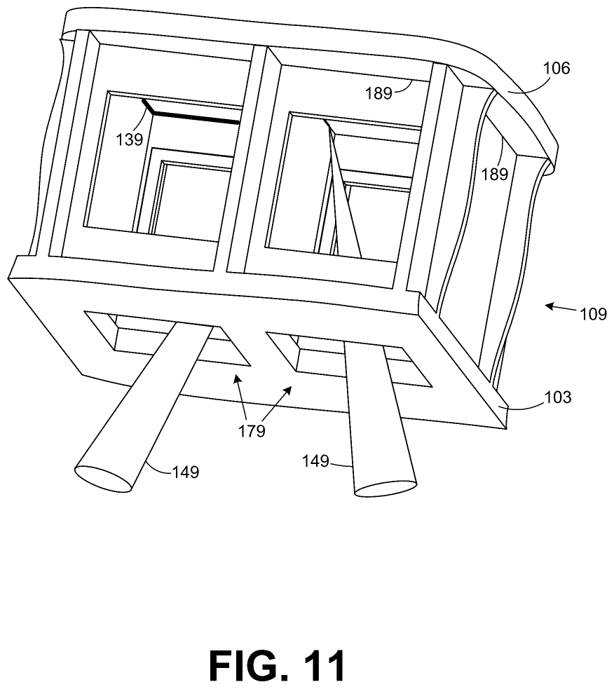

Referring next to FIG. 10, shown is a view that illustrates preparing or conditioning the exposed edges 183 of a portion of the core 109 for attachment to a second plate 106 (FIG. 1) as will be described according to one embodiment.

To this end, the exposed edges 183 of the core 109 are those that are not welded to the first plate 103. To this end, the exposed edges 183 of the core 109 are also the exposed edges 183 of the elongated glass parts 113/163 and the rib glass parts 136.

Regardless of the whether transmission welding or direct welding is employed to attach the core 109 to the second plate 106, the exposed edges 183 of the core 109 are subjected to grinding in order to ensure that the exposed edges 183 of the entire core 109 fall within a predefined tolerance of a common plane. The predefined tolerance may be specified depending upon the requirements of the welds and other requirements of the overall lightweight mirror structure.

The conditioning of the exposed edges 183 of the core 109 is performed in order to reduce any gap size between the edges 183 of the core 109 and the second plate 106 when the core 109 is attached to the second plate 106 due to rough or uneven surfaces of the exposed edges 183.

In one embodiment, the conditioning of the exposed edges 183 may be further accomplished by way of laser edge polishing that optically smooths the exposed edges. The further step of polishing the exposed edges 183 are employed when transmission welding is to be used to attach the second plate 106 to the core 109. In one embodiment, laser edge polishing is accomplished by way of a polishing laser 186 such as a carbon dioxide laser that is employed to smooth the exposed edges 183 by irradiation. Specifically, the polishing laser 186 is scanned along the edges 183 to heat the glass until it softens and flows to create a smooth surface. To create a smooth surface suitable for transmission welding of the exposed edges 183 to the second plate 106, the laser polishing process is controlled so that the polished edge remains flat rather than becoming rounded. This may be accomplished, for example, by minimizing the time that the focus area of the polishing laser 186 dwells on a given location along the exposed edges 183 taking into account the softening point for the type of glass used to create the core 109. In one embodiment, the polishing laser 186 may be scanned along the edges 183 multiple times to achieve the desired result.

Turning next to FIG. 11, shown is a view of a portion of the core 109 that illustrates attachment of the core 109 to a second plate 106 by way of direct welding according to one embodiment. As shown, the second plate 106 is positioned against the core 109 such that the exposed edges 183 (FIG. 10) of the core 109 are in pressured contact with the second plate 106. In such case, a number of abutments, denoted herein as abutments 189, are created between the glass parts 113, 136, 163 of the core 109 and the second plate 106.

Thereafter, a welding laser 149 is used to weld the core 109 to the second plate 106. To this end, the welding laser 149 is directed to the abutments 189 through the laser access openings 179 in the first plate 103 to create laser welded joints 139 in a manner as was described above with respect to FIGS. 6 and 7. Also, in some instances a welding laser 149 may be directed to a side of the abutments 189 along the outside of the core 109 where such abutments 189 are visible from outside the core 109 around the edges of the first and second plates 103 and 106. In addition, further laser access openings 179 may be created in the first plate 103 that are adjacent to outside of the core 109 to allow a welding laser 149 to be directed to the abutments 189 along the outside of the core 109 to create the laser welded joints 139 where appropriate. In this manner, laser welded joints 139 are created between the glass parts 113, 136, 163 that make up the core 109 and the second plate 106.

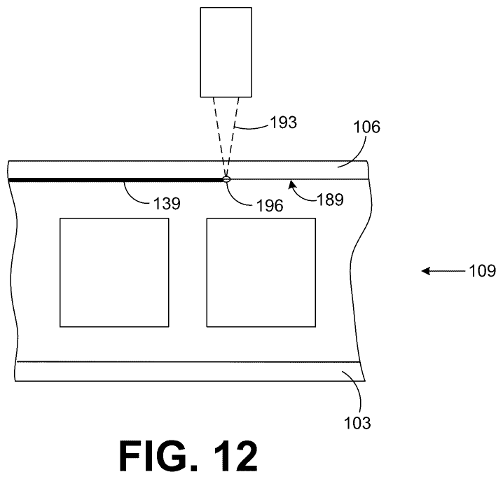

Turning next to FIG. 12, shown is a view that illustrates an alternative approach for attachment of the core 109 to the second plate 106 using transmission welding according to one embodiment. As contemplated herein, the concept of “transmission welding” refers to welding using a laser that is transmitted through a first glass part to cause a weld between the first glass part and a second glass part that is in contact with the first glass part.

In one embodiment, transmission welding is applied to the abutments 189 between the glass parts of the core 109 and the second plate 106, where the glass parts of the core 109 are already laser welded to the first plate 103. In this respect, a transmission welding laser 193 is directed through the second plate 106 and is focused on the interface between the edges 183 (FIG. 10) of the glass parts 113, 136, and 163 (FIG. 10) and the second plate 106.

In order to allow the transmission welding laser 193 to pass through the second plate 106, the surface of the second plate 106 is polished by laser surface polishing as was described above with respect to the regions 116 depicted in FIG. 10. Alternatively, the surface of the second plate 106 may be polished by way of mechanical polishing.

Once the outer surface of the second plate 106 is polished, the formation of laser welded joints 139 is accomplished by directing a transmission welding laser 193 through the second plate 106 to the interface between the abutments 189 formed by the edges 183 of the respective glass parts 113, 136, and 163 and the second plate 106. As such, the focal point of the transmission welding laser 193 is specified so as to fall along the interface. In such case, the temperature in an area 196 around the focal point of the transmission welding laser 193 is able to exceed the melting point of the glass in the area 196. This results in a flow of the glass that ultimately forms laser welded joints 139 between the respective glass parts 113, 136, and 163 and the second plate 106.

In order to accomplish the transmission welding, in one embodiment ultrafast laser welding is employed as a direct and space-selective bonding approach that uses nonlinear absorption. For example, to achieve the transmission welding, one example of the transmission welding laser 193 may comprise an ultrafast pulsed laser such as an 800 KHz, 1030 nanometer laser with a pulse duration of 10 picoseconds. The diameter of the focal spot is specified as approximately 4.22 μm, although other diameters may be specified. In such an example, when the transmission welding laser 193 with high intensity (e.g. 1012 W/cm²) and relatively high frequency of greater than 100 KHz irradiates the interface of a given abutment 189, the laser energy is absorbed through multiphoton and avalanche absorption. Heat is accumulated in the localized area 196, which results in the melting of glass from the glass parts 113, 136, and 163 as well as the second plate 106 to form the laser welded joint 139.

It should be noted that a photodarkening effect may be observed after the laser welding due to photoreduction, for example, of Ti⁴⁺ to Ti³⁺ or due to other factors. However, due to the fact that the lightweight mirror that is ultimately constructed operates based on reflection instead of transmission of the mirror surface, the photodarkening has no effect on the resulting mirror performance.

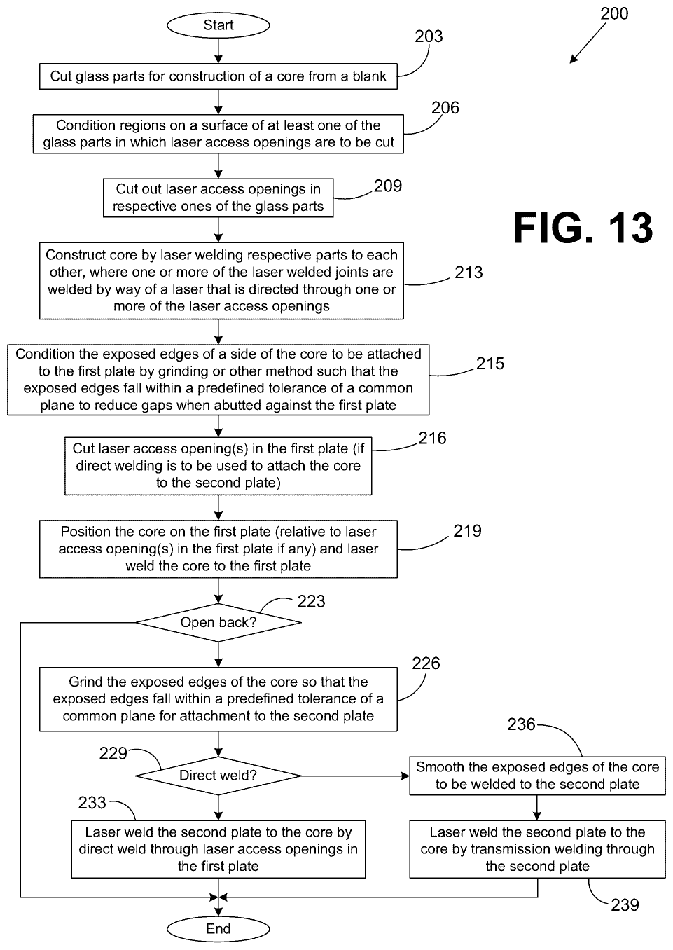

With reference to FIG. 13, shown is a flow chart of a method 200 for constructing a lightweight mirror assembly as described above.

To begin in step 203, glass parts needed to construct a core 109 (FIG. 1) are cut or sliced from one or more blank pieces of glass. As discussed above, such glass parts may include the elongated glass parts 113/163 and the rib glass parts 136. In one embodiment, the elongated glass parts 113/163 and the rib glass parts 136 comprise low thermal expansion (LTE) glass as was discussed above. The first plate 103 and second plate 106 are constructed from a boule, where the first and second plates 103 and 106 may also comprise LTE glass or other type of glass. Further, in one embodiment, an open back mirror may be constructed where the second plate 106 is omitted.

Next, in step 206 the regions 116 (FIG. 3) are conditioned on at least one glass part such as the elongated glass part 113 (FIG. 3) to facilitate cutting for the creation of the laser access openings 126 (FIG. 4). As mentioned above, the conditioning may involve laser polishing or mechanical polishing as described above.

Thereafter, in step 209 the laser access openings 126 are cut out of the respective glass parts such as the elongated glass part 113 as described above. As mentioned above, the cutting is performed in the regions 116.

Then in step 213, the core 109 is assembled by creating laser welded joints 139 (FIGS. 6, 7, and 8) between individual ones of the glass parts including the elongated glass parts 113/163 and the rib glass parts 136. In creating each of the laser welded joints 139, a pair of the glass parts such as the elongated glass parts 113/163 and the rib glass parts 136 are positioned in contact with each other, thereby creating abutments 166 (FIG. 8) therebetween as was discussed above. In one embodiment, a portion of one or more of the laser welded joints 139 is created by directing a laser through a laser access opening 126 toward respective abutments 166 to create at least a portion of a laser welded joint 139.

In one embodiment, each laser welded joint 139 is formed by performing laser welding on both sides of an abutment 143/166. Alternatively, in some embodiments, a given laser welded joint 139 may be formed only on one side of an abutment 166 by performing laser welding on a single side of the abutment 143/166.

In addition, it is understood that the core 109 may be assembled with cells 110 (FIG. 2A) in the form of any polygon constructed from straight sides. Alternatively, the cells 110 may comprise a curved structure such as a circle or a structure that includes both straight sides and curved sides.

Moving on to step 215, once the core 109 is assembled, the exposed edges of the core 109 on a side that is to be abutted against the first plate are conditioned by grinding or other process. This is done so that the exposed edges of this side of the core 109 fall within a predefined tolerance of a common plane. As such, any gaps between such exposed edges and the first plate 103 are minimized within a predefined tolerance to ensure that the joints created by laser welding are consistent meeting specified structural standards.

Next, in step 216, one or more laser access openings 179 (FIG. 9) are created in the first plate 103 if the core 109 is to be attached to the second plate 106 by way of direct laser welding. According to one embodiment, the laser access openings 179 may be created in positions such that they are ultimately located on the inside of the cells 110 of a given core 109. This allows a laser to be pointed toward the inside portions of abutments 189 (FIG. 11) formed between glass parts of the core 109 and the second plate 106 (FIG. 11). In addition, the laser access openings 179 may be created in positions such that they are located on the outside of a core 109 so that a laser can be directed therethrough to the outside portions of the abutments 189 where appropriate. It should be noted that if an open back design for a given mirror or other structure is desired, then laser access openings 179 may not be cut into the first plate 103.

Continuing to step 219, the core 109 is positioned on the first plate 103 relative to one or more laser access openings 179 if such openings have been created. In this manner, a number of abutments 176 (FIG. 9) are created between the glass parts of the core 109 and the first plate 103. A laser is directed toward one or both sides of the abutments 176 to create laser welded joints 139 between the glass parts of the core 109 and the first plate 103 as was described above. Note that if an open back design is desired, then it would not be necessary to create laser access openings 179 in the first plate 103. As such, the core 109 would be positioned in against the first plate 103 in a predefined location.

Thereafter, in step 223, if an open back design for the lightweight mirror is desired, then the method ends as shown. However, if in step 223 an open back design is not desired for the resulting lightweight mirror, then the method proceeds to step 226.

Then in step 226, the exposed edges 183 (FIG. 10) of the glass parts making up the core 109 are conditioned by grinding or other process such that the exposed edges 183 of the core 109 are within a predefined tolerance of a common plane so that any gaps between such edges 183 and the second plate 106 are within an acceptable predefined tolerance.

Next in step 229, if the core 109 is to be attached to the second plate 106 by way of direct welding, the method proceeds to step 233. Otherwise the method proceeds to step 236.

In step 233, the glass parts making up the core 109 are laser welded to the second plate 106. In one embodiment, this is accomplished by positioning the second plate 106 against the exposed side of the core 109, thereby creating a number of abutments 189 between the glass parts of the core 109 and the second plate 106. A laser is directed toward the sides of the abutments 189 to create the laser welded joints 139, thereby attaching the core 109 to the second plate 106. In one embodiment, the laser is directed through laser access openings 179 toward a side of the abutments 189 to create at least a part of the laser welded joints 139. Ultimately, a laser may be directed to one or both sides of the abutments 189 in creating the laser welded joints 139.

Once the core 109 is fully laser welded to the second plate 106, then the method ends as shown.

However, assuming that transmission welding is to be used to attach the core 109 to the second plate 106 as determined in step 229, then in step 236 the exposed edges 183 are further conditioned by a smoothing laser 186 (FIG. 10) as discussed above.

Thereafter, in step 239 the laser welded joints 139 between the glass parts of the core 109 and the second plate 106 are created by way of transmission welding in which a transmission welding laser 193 (FIG. 12) is directed through the second plate 106 as was discussed above with respect to FIG. 12. Once the assembly is created such that the core 109 is laser welded between the first and second plates 103 and 106, in one embodiment the exposed side of the second plate 106 may be subjected to grinding, polishing, or other processing. A mirror may then be formed on the exposed surface of the second plate 106. Such a mirror may involve adding a coating to the exposed surface of the second plate 106, where the coating is configured to reflect extreme ultraviolet (EUV) radiation. An example of a reflective EUV coating is a series of alternating layers of Si and Mo. As contemplated herein, EUV radiation comprise radiation with a wavelength of less than or equal to 100 nanometers. In one example, EUV radiation has a wavelength that falls within the range of 13 to 13.5 nanometers.

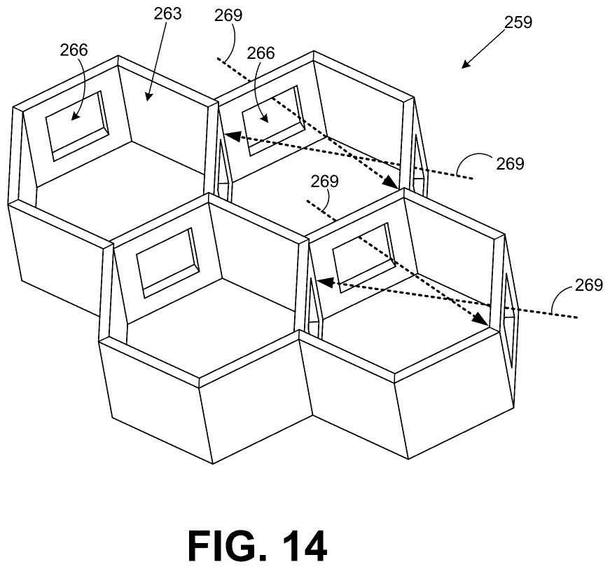

Referring next to FIG. 14, shown is another example of a portion of a core 259 comprising a plurality of polygon cells 263 in the form of hexagons according to one embodiment. The core 259 comprising hexagons provide one example of the many different shapes from which a core 259 may be constructed. To this end, according to various embodiments, the core 259 described herein may be assembled with cell 263 in many different shapes including polygons of different numbers of sides. Alternatively, the cells 263 may also be embodied in the form of a circle, ellipse, or a shape that includes rounded and straight sides. The core 259 includes laser access openings 266 to facilitate the direct welding of various glass parts by lasers 269 in accordance with the various embodiments described herein.

In one embodiment, various groups of glass parts such as three sides of a hexagon or other grouping may be attached to other hexagons or parts of hexagons as shown. In one embodiment each group of glass parts is attached one at a time as the core 259 is assembled.

With reference to FIGS. 1 through 14, in view of the foregoing discussion, below is a description of various example embodiments of the present disclosure. It is understood that the below embodiments are not an exhaustive recitation of the possible embodiments of the present disclosure and that other embodiments are described herein.

Embodiment 1 is an apparatus, comprising a first plate and a core being assembled from a plurality of Low Thermal Expansion (“LTE”) glass parts, where the LTE glass parts are assembled by way of a plurality of first laser welded joints. At least one laser access opening is formed in individual ones of the LTE glass parts, and the core is attached to the first plate by way of a plurality of second laser welded joints.

Embodiment 2 comprises an apparatus as set forth in embodiment 1, further comprising a second plate, the core being positioned between the first plate and the second plate, and the core being attached to the second plate by way of a plurality of third laser welded joints.

Embodiment 3 comprises an apparatus as set forth in embodiments 1 or 2, wherein the LTE glass parts have a coefficient of thermal expansion (CTE) of less than or equal to 45 ppb/° Celsius over an approximate temperature range from 5° Celsius to 35° Celsius.

Embodiment 4 comprises an apparatus as set forth in embodiments 1 or 2, wherein the LTE glass parts further comprise silica-titania glass that has a titania (TiO₂) content in the range from 7.0 wt % to 7.5 wt %.

Embodiment 5 comprises an apparatus as set forth in embodiments 1 through 4, wherein the core further comprises a plurality of cells, where each of the cells is assembled in a form of a polygon.

Embodiment 6 comprises an apparatus as set forth in embodiments 1 through 4, wherein the core further comprises a plurality of cells, where each of the cells is assembled in a form of a rectangle.

Embodiment 7 comprises an apparatus as set forth in embodiments 1 through 6, wherein the laser access openings further comprise a plurality of first laser access openings, the apparatus further comprising a plurality of second laser access openings in the first plate.

Embodiment 8 comprises an apparatus as set forth in embodiments 1 through 7, wherein individual ones of the first and second welded joints comprise a continuous segment extending along an edge of a respective one of the LTE glass parts.

Embodiment 9 comprises an apparatus as set forth in embodiments 1 through 7, wherein individual ones of the first and second laser welded joints are formed on a first and second side of a respective one of the LTE glass parts.

Embodiment 10 comprises an apparatus as set forth in embodiments 1 through 9, wherein individual ones of the third laser welded joints are formed through the second plate by way of transmission welding.

Embodiment 11 comprises an apparatus as set forth in embodiments 1 through 10, wherein a mirror is formed on an exposed side of one of the first and second plates.

Embodiment 12 comprises an apparatus as set forth in embodiments 1 through 11, wherein individual ones of the laser access openings are formed by a cut through a respective one of the LTE glass parts, thereby creating an interior edge of a respective one of the laser access openings, where the interior edge is substantially perpendicular to a surface of the LTE glass part.

Embodiment 13 comprises an apparatus as set forth in embodiments 1 through 11, wherein individual ones of the laser access openings are formed by a cut through a respective one of the LTE glass parts, thereby creating an interior edge of a respective one of the laser access openings, where an angle between the interior edge and a surface of the LTE glass is less than 90 degrees.

Embodiment 14 is a method, comprising cutting at least one laser access opening in at least one of a plurality of glass parts, and assembling a core by creating a plurality of laser welded joints between individual ones of the glass parts. The assembling further comprises positioning a pair of the glass parts to create an abutment therebetween, and directing a laser through the at least one laser access opening toward the abutment to create one of the laser welded joints.

Embodiment 15 comprises a method as set forth in embodiment 14, wherein the glass parts further comprise low thermal expansion (LTE) glass parts.

Embodiment 16 comprises a method as set forth in embodiments 14 or 15, wherein the abutment comprises a first abutment, and the assembling further comprises positioning another pair of the glass parts to create a second abutment therebetween, and directing the laser toward the second abutment to create a second one of the laser welded joints.

Embodiment 17 comprises a method as set forth in embodiments 14 or 15, wherein the laser welded joints further comprise a plurality of first laser welded joints, and the abutment comprises a first abutment, the method further comprising positioning the core against a first plate, thereby creating at least one second abutment between at least one of the glass parts and the first plate, and directing the laser toward the at least one second abutment to create at least one second laser welded joint between the at least one of the glass parts and the first plate.

Embodiment 18 comprises a method as set forth in embodiments 14 or 15, wherein the at least one laser access opening further comprises at least one first laser access opening, the laser welded joints further comprise a plurality of first laser welded joints, and the abutment comprises a first abutment, the method further comprising cutting at least one second laser access opening in a first plate, positioning the core against a second plate, thereby creating at least one second abutment between at least one of the glass parts and the second plate, and directing the laser toward the at least one second abutment through the at least one second laser access opening to create at least one second laser welded joint between the at least one of the glass parts and the second plate.

Embodiment 19 comprises a method as set forth in embodiments 14 or 15, further comprising conditioning a region of a surface of the at least one of the glass parts, wherein the cutting is performed within the region.

Embodiment 20 comprises a method as set forth in embodiment 19, wherein the conditioning of the region results in an Arithmetic Roughness Average Ra of approximately 1 micron in the region.

Embodiment 21 comprises a method as set forth in embodiment 18, further comprising forming a mirror on an exposed side of the second plate.

Embodiment 22 comprises a method as set forth in embodiments 14 or 15, wherein the assembling of the core further comprises creating a plurality of cells of the core, where individual ones of the cells are in a shape of a polygon.

Embodiment 23 comprises a method as set forth in embodiment 22, wherein the polygon further comprises a rectangle.

Embodiment 24 comprises a method as set forth in embodiments 14 or 15, wherein the at least one laser access opening further comprises at least one first laser access opening, the laser welded joints further comprise a plurality of first laser welded joints, and the abutment comprises a first abutment, the method further comprising positioning the core against a second plate, thereby creating at least one second abutment between at least one of the glass parts and the second plate, and directing a transmission laser toward the at least one second abutment through the second plate to create at least one second laser welded joint between the at least one of the glass parts and the second plate.

Embodiment 25 comprises a method as set forth in embodiment 24, further comprising polishing an open face of the second plate before directing the laser through the second plate.

Embodiment 26 comprises a method as set forth in embodiments 14 or 15, further comprising positioning the core between a first plate and a second plate.

Embodiment 27 comprises a method as set forth in embodiments 14 or 15, wherein the positioning of the pair of the glass parts to create the abutment further comprises pressing an edge of a first one of the glass parts against a face of a second one of the glass parts.

Embodiment 28 comprises a method as set forth in embodiments 14 or 15, wherein the directing the laser through the at least one laser access opening toward the abutment to create one of the laser welded joints further comprises passing the laser along an edge of the abutment a plurality of times.

Embodiment 29 is a method, comprising cutting at least one laser access opening in a first one of a plurality of low thermal expansion (LTE) glass parts, positioning an edge of a second one of the LTE glass parts against the first one of the plurality of LTE glass parts to create an abutment therebetween, and directing a laser toward the abutment to create a laser welded joint between the first and second ones of the plurality of LTE glass parts.

Embodiment 30 comprises a method as set forth in embodiment 29, wherein the laser welded joint is one of a plurality of laser welded joints, and the abutment further comprises a first abutment, the method further comprising assembling a core by creating the plurality of laser welded joints between individual ones of the LTE glass parts, wherein at least one of the laser welded joints is formed by positioning a pair of the LTE glass parts to create a second abutment therebetween, and directing a laser through the at least one laser access opening toward the second abutment to create one of the laser welded joints.

Embodiment 31 comprises a method as set forth in embodiment 29, wherein the at least one laser access opening further comprises a plurality of laser access openings, the method further comprising positioning the edge of the second one of the LTE glass parts between a pair of the laser access openings.

Embodiment 32 comprises a method as set forth in embodiment 29, further comprising conditioning a region of a face of the at least one of the plurality of LTE glass parts, wherein the cutting is performed within the region.

Embodiment 33 comprises a method as set forth in embodiment 32, wherein the conditioning of the region results in an Arithmetic Roughness Average Ra of approximately 1 micron in the region.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An apparatus, comprising:
a first plate;
a core attached to the first plate by a first plurality of laser-welded joints, the core assembled from a plurality of glass parts, the glass parts connected by a second plurality of laser-welded joints; and
an opening in at least one of the glass parts.

2. The apparatus of claim 1, wherein the first plate comprises glass.

3. The apparatus of claim 2, wherein the glass of the first plate comprises silica-titania glass.

4. The apparatus of claim 1, wherein the first plate comprises an opening.

5. The apparatus of claim 1, wherein the first plate comprises a plurality of openings.

6. The apparatus of claim 1, wherein each of the glass parts comprises silica-titania glass.

7. The apparatus of claim 1, wherein each of the plurality of the glass parts includes an opening.

8. The apparatus of claim 1, wherein each of the plurality of glass parts is attached to the first plate by one of the first plurality of laser-welded joints.

9. The apparatus of claim 1, further comprising a second plate, the core being positioned between the first plate and the second plate, the core being attached to the second plate by a third plurality of laser-welded joints.

10. The apparatus of claim 9, wherein
the first plate comprises an opening; and
a line extending through the opening of the first plate intersects a point along one of the third plurality of laser-welded joints.

11. The apparatus of claim 9, wherein the first plate, each of the plurality of glass parts, and the second plate comprise silica-titania glass.

12. A method, comprising:
a first attachment step, the first attachment step including using a laser to form a laser weld between a first plate and a glass part, the glass part including an opening;
wherein the first plate and the glass part have an average coefficient of thermal expansion (CTE) less than or equal to 45 ppb/° C. over a temperature range from 5° C. to 35° C.

13. The method of claim 12, wherein the first plate and the glass part comprise silica-titania glass.

14. The method of claim 12, wherein the first plate includes an opening.

15. The method of claim 14, wherein the laser forms a laser weld between the glass part and a second plate in contact with the glass part.

16. The method of claim 12, wherein the first attachment step includes forming a laser welded joint between the first plate and each of a plurality of the glass parts.

17. The method of claim 16, wherein the plurality of glass parts are positioned to define a plurality of cells, each of the cells having a polygonal cross-sectional shape.

18. The method of claim 12, further comprising forming the opening of the glass part.

19. The method of claim 18, wherein the opening of the glass part is formed with a laser and the glass part is transparent at the wavelength of the laser.

20. The method of claim 12, further comprising placing a second plate on contact with the glass part and forming a laser weld between the second plate and the glass part, the forming comprising directing a laser beam through the second plate, the second plate transparent at the wavelength of the laser beam.
